(19) United States
(12) Patent Application Publication
(10) Pub. No.: US 2010/0115074 A1
(43) Pub. Date: May 6, 2010

(54) Method, Apparatus, and Computer Program for Disconnecting Network Devices

(76) Inventor: Antti Tapiola, Kisko (FI)

Correspondence Address: Hollingsworth & Funk, 8500 Normandale Lake Blvd., Suite 320, Minneapolis, MN, 55437, US

(21) Appl. No.: 12/262,551

(22) Filed: Oct. 31, 2008

(51) Int. Cl. G06F 15/173

(52) U.S. Cl. 709/223

(57) ABSTRACT

Disconnecting network devices involves receiving, at a service of an apparatus via a first network, a signal directed to an operational component of the apparatus. The operational component interacts via an ad-hoc, peer-to-peer home network, and the service operates independently of the operational component. The operational component is disconnected from the ad-hoc, peer-to-peer home network in response to receiving the signal

### TECHNICAL FIELD

This specification relates in general to computer networking, and more particularly to a system, apparatus and method for disconnecting network devices.

### BACKGROUND

The ubiquity of cellular phones has led to demands for more general purpose computing features in these devices. For example, programs such as personal information managers and email clients are particularly useful when combined with the always-at-ready, always-connected nature of cell phones. This has led to demand for phones that can connect to a variety of networks. For example, mobile devices may include features that allow interaction with other consumer electronics devices.

A standard known as Universal Plug and Play™ (UPnP) provides a way for disparate processing devices, including mobile devices, to exchange data over local networks. The UPnP standard defines an architecture for peer-to-peer network connectivity utilizing a wide variety of electronic devices. The UPnP standard includes standards for service discovery, and is mainly targeted for proximity or ad hoc networks.

The UPnP model is designed to support zero-configuration networking and automatic discovery for a wide variety of device categories. This allows a device to dynamically join a network, obtain an Internet Protocol (IP) address, convey its capabilities, and learn about the presence and capabilities of other devices. Many local network and Internet-based protocols such as Dynamic Host Configuration Protocol (DHCP) and Domain Name Service (DNS) may be included in a UPnP network. A device can leave a UPnP network smoothly and automatically without leaving any unwanted state behind.

As more devices become UPnP capable, there will be greater demand for seamless and reliable interaction between these devices. Further, through the use of remote access technologies, people can take advantage of their UPnP networks even when away from home.

### SUMMARY

The present specification discloses a system, apparatus, computer program, and method for disconnecting network devices. In one aspect, a method, apparatus, and computer program receive, at a service of an apparatus via a first network, a signal directed to an operational component of the apparatus. The operational component interacts via an ad-hoc, peer-to-peer home network, and the service operates independently of the operational component. The operational component is disconnected from the ad-hoc, peer-to-peer home network in response to receiving the signal.

In one variation, the operational component may reconnect to the ad-hoc, peer-to-peer network in response to receiving the signal. In such a case, disconnecting and reconnecting the operational component may involve one or both of resetting one or more network protocol stacks and/or resetting processing hardware of the apparatus.

In other variations, the first network may include a cellular data network. In another variation, the service may operate on a first processor that is independent of a processor of the apparatus. In such a case, the first processor may be contained in a peripheral device that is removably coupled to the apparatus. In yet another variation, the signal may be received via a remote access server. In such a case, the signal may originate from a user device that is remotely situated from the ad-hoc, peer-to-peer network.

In another aspect, a method, apparatus, and computer program receive a signal directed an operational component of the ad-hoc, peer-to-peer home network. Based on the signal, a target device is determined that hosts the operational component. The signal is sent to a service of the target device to disconnect the operational component from the ad-hoc, peer-to-peer home network. The service operates independently of the operational component.

In one variation, the signal may be received at a remote access interface that facilitates accessing the ad-hoc, peer-to-peer home network via an external network. In another variation, the signal may be received via a cellular data network. In yet another variation, sending the signal to the service of the target device may further cause the operational component to reconnect to the ad-hoc, peer-to-peer network after disconnecting.

These and various other advantages and features of novelty are pointed out with particularity in the claims annexed hereto and form a part hereof. However, for a better understanding, reference should be made to the drawings which form a further part hereof, and to accompanying descriptive matter, in which there are illustrated and described representative examples of systems, apparatuses, computer programs, and methods in accordance with the invention.

### BRIEF DESCRIPTION OF THE DRAWINGS

The invention is described in connection with the embodiments illustrated in the following diagrams.

FIG. 1 is a block diagram of a component architecture according to example embodiments of the invention;

FIG. 2 is a sequence diagram illustrating disconnecting and reconnecting a device according to an example embodiment of the present invention;

FIG. 3 is a block diagram illustrating a removable hardware component according to an example embodiment of the present invention;

FIG. 4A is a flowchart illustrating a procedure for disconnecting a network device according to embodiments of the invention;

FIG. 4B is a flowchart illustrating a procedure for providing a disconnection service according to embodiments of the invention;

FIG. 5 is a block diagram illustrating an example user device according to an example embodiment of the invention; and

FIG. 6 is a block diagram illustrating an example computing structure suitable for providing services according to embodiments of the present invention;

### DETAILED DESCRIPTION

In the following description of various example embodiments, reference is made to the accompanying drawings that form a part hereof. It is to be understood that other embodiments may be utilized, as structural and operational changes may be made without departing from the scope of the invention.

Generally, the present description relates to increasing the reliability of ad-hoc, peer-to-peer networking. In one aspect, methods, apparatuses and computer programs are described that allow disconnecting (locally and/or remotely) a non-responding device from a local area network. In order to facilitate an understanding of the invention, various aspects of the present invention may be described in the context of a Universal Plug-and-Play™ (UPnP) home networking environment. It will be appreciated, however, that the methods, apparatuses, and computer program products described herein may be applicable in any system or application where ad-hoc data communications between devices such as consumer and mobile electronics is desired. For example, data transfer technologies such as X10, infrared data transfer, power line networking, Zeroconf, Bluetooth, etc., may be used with or instead of UPnP to provide some level of intercommunication in a local environment.

Networks technologies such as UPnP are generally associated with home use. For example, it may be assumed that a UPnP network is intended for operation in a physical area and with a number of devices reasonably associated with a home, small office, etc. Thus UPnP implementations may not need to take into account features associated with large, public networks, such as global scalability, high levels of internal security, etc. To facilitate remote access of UPnP networks, specific adaptations have been proposed that allow users to remotely access UPnP devices securely from public networks (e.g., the Internet) without requiring significant changes to the UPnP standards.

For example, remote access of a home network may utilize a specialized remote access device that is coupled to the home network. This device may be accessible via the Internet, and provides a secure way to access the home network. There has recently been progress in defining standards related to remote access of UPnP networks. While there has not yet been a large-scale deployment of UPnP remote access products, it is contemplated that there may be challenges in such systems responding reliably and with high availability. For example, an individual may rely on a remotely controlled device for some important operation at a time when there is nobody on the premises. This reliance may be problematic if, for example, a non-responding application cannot be closed, or such device running the application cannot be restarted if needed. It is also possible that, even when the home devices are working properly, there may be problems with the home network. Such network problems may be caused by failures of the home local area network (LAN) and/or due to failures in external wide area networks (WAN) used to access the LAN.

It some UPnP usage scenarios, it is assumed devices are nearby, such as in range of wireless LAN (WLAN), or even all in a single room at home (e.g., within line of sight). Such devices may include a hardware interface for reset/reboot in the event of a problem. As a last resort, most devices can be disconnected from and reconnected to electrical power to force a reset. In a scenario where UPnP devices are physically accessible, the need to infrequently reset or reboot the device by hand, while possibly annoying, may not render the device unusable for its intended purpose. However, if users are relying on the same type of device to reliably operate remotely, the device may stop working just when it is needed most, and there may be no solution to reset the device from a remote location.

It should be appreciated that the need or desire to reset a device without directly accessing the device is not limited to remote access scenarios. Even a user on the premises may appreciate being able to automatically reset a device, particularly of the device is on another floor, in a hard to access area, etc. Further, such capabilities may be automated, so that a single reliable entity can determine failed devices and reset those devices without the user even having to know about it. Thus, while embodiments may be described below in relation to remote access, it will be appreciated that the methods, apparatuses, software, and systems described herein are not so limited.

Generally, as hardware and software become more complex, there may be an associated rise in the possibility of problems arising. This is evident in modern personal computers, where a seemingly indefinite number of combinations of hardware and software inevitably makes it impractical to predict or test for all sources of interoperability failure. The number of combinations is compounded further on networks, such as UPnP networks, that rely on high levels of autonomous network interactions, especially if interaction between tens or hundreds of diverse devices is possible.

Problems on a UPnP network may show themselves in many ways. For example, control commands may not be available in a control point or listed by the controlled device any more. In other cases, operations may happen so slowly that user wants to cancel started operations. In other cases, the user may want to reset or unplug the device from network as occasionally (e.g., mitigate the effects of memory leaks, conserve power, reduce security risks, etc.) even when no problems are exhibited. Thus, in order to provide these options, a mechanism for achieving these goals is described below.

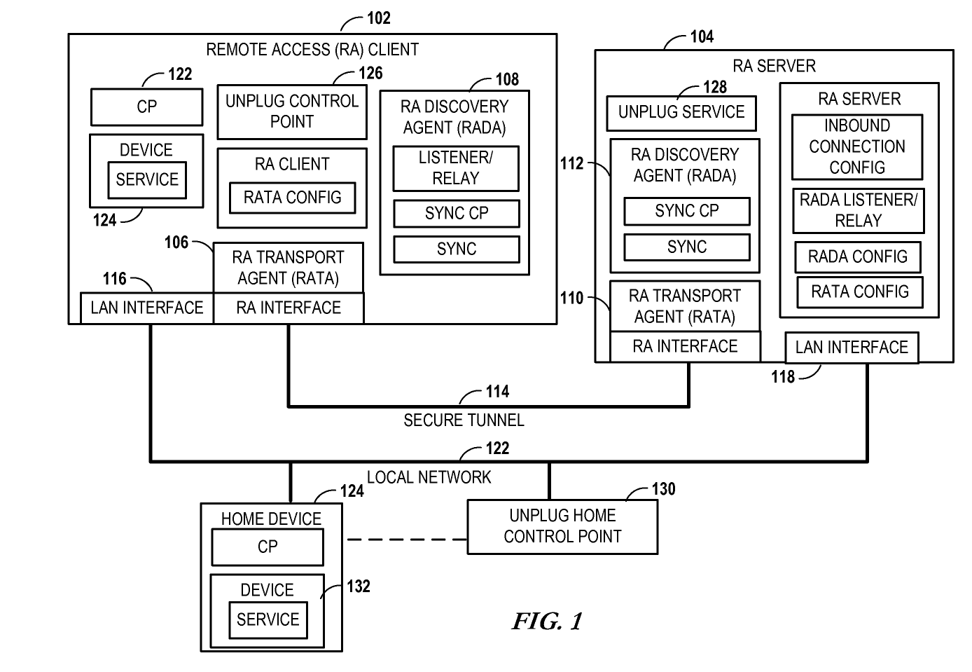

In reference now to FIG. 1, a block diagram shows a device architecture according to example embodiments of the present invention. The block diagram includes remote access components which enable a remote UPnP device or UPnP control point to connect to the home network and to interact with the UPnP entities physically attached to a home network. The UPnP Remote Access (RA) architecture defines two entities known as remote access client (RAC) 102 and remote access server (RAS) 104. Generally the RAC 102 includes functionality to access a home UPnP network (e.g., represented as local network 122) via an external network (e.g., the Internet, cellular data networks, etc.). The RAS 104 facilitates such connections, by acting as an intermediary between the remote access client 102 and the home UPnP network 122.

The UPnP Remote Access (RA) architecture defines two functional components known as the Remote Access Transport Agent (RATA) and Remote Access Discovery Agent (RADA).These two components may be associated with both the RAC 102 (as represented by RATA 106 and RADA 108) and the RAC 104 (as represented by RATA 110 and RADA 112). The corresponding RATA 106, 110 establish a secure communication channel 114 between remote devices (e.g., device 102) and the home network. The RADA 108, 112 synchronize UPnP device information and content exchanges between RAC 102 and the home network 122.

The RAC 102 may also contain a standard network interface 116 for direct communication via a local network 120 using local media and protocols, such as Ethernet, WiFi, etc. Generally, the remote access features of the RAC 102 may not be needed when directly coupled to the local network 120. The RAS 104 also contains a local interface 118 that facilitates coupling the RAC 102 to the local network 120 when the RAC 102 is remote.

The RAC 102 may contain one or more standard UPnP devices, represented here as control point (CP) 122 and service device 124. The CP 122 may contain a user interface that enables control of other UPnP services/devices, and the device 124 provides one or more services to entities of the UPnP network 122. The remote access features allow these types of standard UPnP devices 122, 124 to seamlessly access the local network 122 even when remote (e.g., when a direct connection to network 122 via interface 116 is not possible). To account for less than ideal remote access conditions (e.g., low bandwidth connections, intermittent connectivity, latency, etc.) the RATA 106, 110 and RADA 108, 112 may manage various aspects of network state on behalf of the remote UPnP devices 122, 124 and locally situated UPnP devices, such as home device 124.

Sometimes electronic devices may become non-responsive, either fully or partially. It is also possible that a network of such devices may enter a corrupt or non-responsive state. For example, a UPnP network relies on automatic discovery and utilization of network services, and therefore participating devices may need to have separately maintained versions of state that describes the network. If one device becomes nonresponsive, the whole network may become fully or partially nonresponsive. In such a case, even if each device works properly own its own, the configuration of the whole UPnP network may become misaligned/corrupted. In such an event, the user may not be able to use the services of the network in the normal way.

As will be described in greater detail below, a number of different adaptations to network devices can help recover from non-responsive device and networks states. In case of individual devices, it maybe that automatic or targeted reset of a non-responding device is desired. The device may be reset in a number of ways, include “soft” reset of some software components and “hard” reboot, e.g., processor reset and/or power-off then power on. This type of reset may be facilitated by software and hardware components resident on the devices, and may reset commands may be targeted to reset multiple devices as part of system reset sequence.

In the case where network level state becomes corrupt, a new setup phase for the UPnP network (or part of the network) may be initiated. This may be in the form of a “soft” reset of each affected device. In such a case, the devices may rebuild their individual and/or collective network state data, and this may suffice to bring the network again up and working as expected.

To facilitate resetting devices and networks, a system may employ one or more UPnP components, referred to herein as “unplug control points” and “unplug services.” Such components can be included into one or more UPnP entities, as represented by components 126 and 128 in respective RAC 102 and RAS 104 of FIG. 1. Component 126 is an unplug control point that facilitates user inputs for resetting system components, such as through explicit reset commands and through configuration of conditions under which automatic resets may occur. Component 128 is an unplug service that receives and processes commands. The unplug service 128 may be used to reset the RAS 104 itself, as other entities of the local network 122 (e.g., home device 124). The unplug control point 126 may also include services that enable independent and/or external reset of the RAC 102. Further, the local network 122 may include other analogous unplug components, here shown as home control point 130. The unplug control point 130 may be a separate network device, or be coupled to or part of the home device 124. For example the unplug control point 130 may be used to reset one or more UPnP devices 132 of home device 124, each UPnP device potentially hosting one or more UPnP services.

The operation of these components 126, 128 may be independent of the main functionality of the devices 102, 104, 124 in which they reside and/or control. Through independent operation, the unplug services may be available even when the main the host/target devices 102, 104, 124 are otherwise non-responsive. In one example embodiment, the components 126, 128 could include processors and other hardware that operate independently from processors and circuitry of the host devices 102, 104. Additionally or alternatively, the main functionality of the devices 102, 104 could include a version of the unplug service that enables a fully or partially working device to unplug from the UPnP network for a certain time period (e.g., “soft” reset).

While the use of the reset components 126, 128 as described herein is not limited to remote access scenarios, such components 126, 128 may include features that are targeted for remote access reset. For example, the components 126, 128 may be able to communicate over a direct connection that bypasses the local network 122 and secure connection 114 for cases where some primary network infrastructure component has failed (e.g., gateway, firewall, router, etc.). For example, one embodiment described below includes a reset device configured as a USB modem that could in some cases provide an alternative channel to the home network.

The embodiments described herein enable the following technical effect of instructing UPnP devices to unplug from a UPnP network. The embodiments may further enable a hardware reset of the device, such as by switching the power off from power-consuming devices or forcing a processor power-on reset. All these technical effects may be obtained either remotely or locally (e.g., for purposes of reliability, availability, security, reducing power consumption, etc.).

In some cases, a user may want to cancel an operation which works correctly from the point of view of a device or protocol, but not from the view of the end user. For example, a Simple Object Access Protocol (SOAP) action or Hypertext Transfer Protocol (HTTP) media transfer may seem non-responsive to the user. Other situations where a program is waiting for a timeout, such as waiting for a non-responsive Domain Name Service (DNS) server to reply before switching over to the backup DNS server. Such actions/transfers may affect device operation negatively, such as where a single-threaded program is blocking other actions while waiting for a slow operation to complete. In such a case, control may be recovered if one of the devices in the network is unplugged from protocol point of view. For example in a file transfer, by unplugging the destination media server will cause source media server to cancel the file copy transfer as well.

In some scenarios, Simple Service Discovery Protocol (SSDP) messaging may be used to accomplish these resets. For example, the RADA 108, 112 in FIG. 1 may include a SOAP interface for controlling unplug components 126, 128. If supported by the hardware, the device can be restarted or reset. In other scenarios, it may be useful to communicate to someone at home (if possible) and request that they reset the device. This could be implemented, for example, by sending messages to any active unplug control points 126, 130 which can then alert the user regarding the problem. By having a user alert protocol for problem cases, people at home could affect a device or system reset, e.g., by rendering a dialog (e.g., audibly, visually) such as “Please Restart Media Server X.”

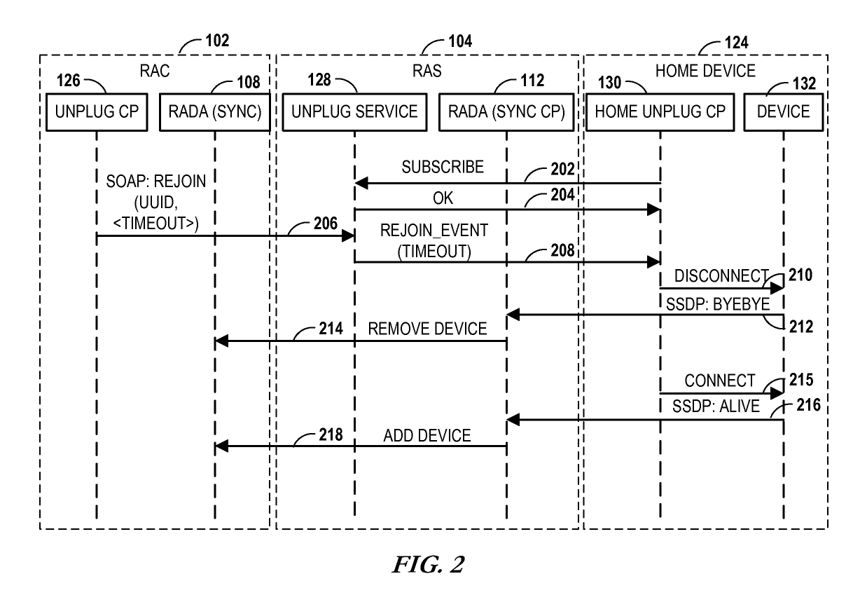

In reference now to FIG. 2, a sequence diagram illustrates a rejoin scenario according to an example embodiment of the invention, wherein the same reference numbers are used to designate analogous components as shown and described in FIG. 1. Generally, the diagram of FIG. 2 shows a sequence of events initiated by an RAC 102 to reset a home device 124 via an RAS 104. In this example, the home device 124 may be physically and/or logically coupled to a home unplug control point 130 that enable resetting a UPnP device 132 hosted by the device 124. In this example case, the UPnP device 132 is commanded to leave a UPnP network, then join the network again. A timeout between leaving the network and joining can be defined by the control point 130.

The control point 130 first subscribes 202, 204 to the unplug service 128, which here is part of the RAS 104. It will be appreciated that other entities may host the unplug service 128 and equivalents. In this example, the unplug control point 126 of remotely coupled RAC 102 initiates 206 a reset of device 132 via a SOAP method invoked via a secure external connection. It will be appreciated that the actions described further below need not occur in a remote access scenario, thus the rejoin method call 206 may sent directly via a local network to the RAS 104 or some other locally accessible entity. The SOAP call 206 includes a Universally Unique Identifier (UUID) uniquely associated with the targeted control point 130 and/or the hosting device 124, as well as a timeout value. The timeout value indicates a time period that should elapse between leaving the network and rejoining the network.

In response to the rejoin method 206, the unplug service 128 sends a rejoin event 208 to the home control point 130, e.g., using a unicast event according to UPnP Device Architecture (DA) 1.0. Another option is to send the event 208 using multicast eventing if the implementation follows DA 1.1. This event 208 is communicated 210 directly or indirectly to cause the device 132 to reset according to its own defined behaviors on the network. Such a reset may involve resetting any combination of applications, protocols stacks, system services, operating systems, and hardware.

In the illustrated example, the response to the rejoin command 206, 208 involves ordering 210 the device 132 to disconnect, which results in the device 132 sending an SSDP “byebye” message 212 to disengage the device 132 from the network. After passage of the time defined in the “timeout” parameter of event 208, the unplug control point 130 sends a connect command 215 to the device 132, which results in the device 132 sending an SSDP “alive” 216 to advertise its services. Receiving the connect command 215 may require the device 132 being able to listen UPnP events, or to react to some other triggering means such as electric or electromagnetic signals outside of UPnP. Utilizing signals outside of UPnP for connect command 215 may require the unplug control point 130 to implement modules capable of transmitting such signals

The sending of the SSDP messages 212, 216 results in respective removal 214 and adding of device 132 (and its associated services) to the state data of the RADA 108. After these updates, any components of the user device that uses RAC 102 for service discovery should have correct state relative to the reset device 132. There may need to be certain delay between SSDP “byebye” and “alive” messages 212, 216. Therefore if the timeout value in the rejoin event 208 is less than this minimal value, the control point 130 may instead perform connection/disconnection 210, 215 according to that minimal value.

It will be appreciated that many variations of the illustrated scenario are possible. For example, when the RAC 102 is locally coupled to the network, the SOAP call 206 and/or event 208 may be sent via a different path than the RAS 104. In some cases, the device 124 itself may host an equivalent to the service 128, thereby allowing the RAC 102 (or any other user device) to directly send the messages/events to the home device 124 and cause the UPnP device 132 to leave and rejoin the network.

In another variation, the timing between the SSDP “byebye” and “alive” messages 212, 216 may be controlled by the device 132 itself, thus the unplug control point 130 would only need to communicate a single event (e.g., event 210). However, in cases where the reset involves a hardware restart of the home device 124, the timing logic may be kept in separate control point hardware 130, which may be able to operate independently of the hardware of device 124.

As mentioned above, the SSDP “byebye” and “alive” messages 212, 216 may occur in response to the device 132 resetting software and/or hardware states. In one example, this may involve stopping and starting one or more applications and/or system services that handle UPnP actions. In other scenarios, this may involve restarting protocol stacks, such as HTTP, TCP/IP, etc. Finally, the device 132 may reboot its operating system, or perform a hardware reset or power cycling.

The rejoin event 206, 208 may generally result in a commanded device 132 to at least send an SSDP “byebye” message to leave a UPnP network. This event may help to solve issues that impact other devices in a network. The device 132 may be allowed to join to the network again after some minimal amount of time has passed, e.g., five (5) seconds. The rejoin event is just one type of event anticipated for communication by unplug components 126, 128, 130. Additional unplug events include “cancel action execution,” which causes an existing UPnP SOAP action to canceled in a commanded device (e.g., home device 124). The cancelled action may be, for example, a search request and/or HTTP file transfer operations.

An “unplug device” event cause a commanded device (e.g., home device 124) to send SSDP byebye message to leave a UPnP network without rejoining. This unplug event can be used in cases where the user does not need the device anymore. In such a case, unplugging the device may increase security and conserve power. In FIG. 2, this may be shown the same sequence as the “rejoin” event, except the “unplug” sequence stops at event 214, and there may be no need to communicate a “timeout” value.

A “reset” event causes a UPnP device (e.g., home device 124) to perform a hardware reset and join to the network when possible, e.g., as part of startup sequence. Thus the “reset” event sequence may appear the same as the “rejoin” event, in FIG. 2, except that there may be a system or hardware reset (e.g., network stack reset) between the SSDP “byebye” and “alive” messages 212, 216. In such a case, it may be assumed that the network stack and hardware are active and able to receive connect event 215.

A “join” event may cause a device to join to the network by sending SSDP “byebye” 212 followed by “alive” 216 messages in some predetermined time period. In some cases, this may require that the unplugged device listen HTTP events on the UPnP network. In other cases, an independently running piece of hardware may be able to receive such a command via UPnP or out-of-band. The “join” event may not always require the initial “byebye” message 212, such as where it can be assumed the device 132 left the network in the proper state. If so, the “join” sequence may appear the same as the sequence in FIG. 2, except without events 210, 212, and 214, and may not require the communication of a timeout value.

In reference again to FIG. 1, the unplug service 128 may at least manage incoming unplug events, determine a target unplug control point, e.g., control 130, on the local network and/or remote unplug control point such as 126 in RAC 102. The unplug service 128 may further provide diagnostic services targeted toward the RAC 102 and or home devices 124. The diagnostic service may track diagnostic data such as metrics of network traffic at home, UPnP devices in the network, and remote UPnP devices. These metrics may include quantity and identity of connected devices, device status (e.g., running, low power mode, standby), network bandwidth utilization, central processing unit (CPU) load and application memory usage of devices, idle times, continuous running time, etc. CPU load and memory usage of devices may be shown as traffic lights, indicating light or heavy load.

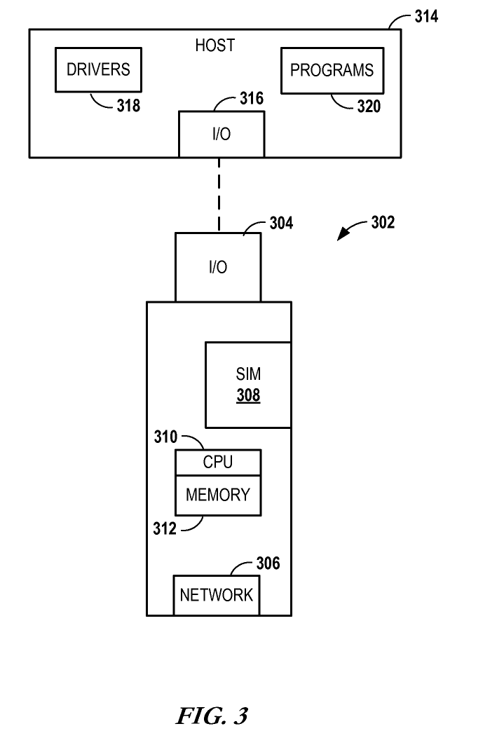

The unplug diagnostic may also provide monitoring services. For example, the service may have an interface to firewall at home, and alert the end user in a case of alarm. The diagnostic service may communicate such alerts via a primary public internet interface and/or by calling or indicating through a specialized component discussed in relation to FIG. 3. It may also be possible to configure self-diagnostic actions to occur in response to some event or alarm. For example, an alarm could trigger automatic shutdown of all UPnP remote access operations. Such operations could be restarted automatically at a later time, or an indication may be sent to the end user, who can try to later to start operations remotely.

In the case of resetting network components, it may be possible that the network itself is not locally or remotely accessible. For example, if a device is erroneously flooding the home network with data, then it may be difficult to send a signal to the device via the network, even locally. Thus, in one example embodiment shown in FIG. 3, UPnP reset components may utilize backup connectivity, such as via an alternate network path. As shown in FIG. 3, a hardware attachment 302 may be utilized to the home network for cases where alternate access paths/networks may be needed.

The attachment 302 may be a small low power device capable of being removably attached to other UPnP devices, as represented by host device 314. The attachment 302 may include an I/O interface 304 capable of removably connecting the attachment 302 to compatible I/O interface 316 of host device 314. The interfaces 304, 316 may employ an I/O standard such as Universal Serial Bus (USB), RS-232 serial port, Standard Parallel Port (SPP), IEEE 1394, etc. The interface 304 may encompass multiple I/O standards, such as IP over USB, for example.

Generally, the interface 304 communicates with a target UPnP apparatus 314 and provides an alternate path to reset the target apparatus 314. Installation of the attachment 302 may include provisioning the target apparatus 314 with drivers 318 and/or programs 320 that ensure reliable reset of functionality even when the apparatus 314 may be malfunctioning and/or the local UPnP network is degraded or inoperative. The communications between the attachment 302 and target UPnP apparatus 314 may occur via UPnP network channels (e.g., the hardware acts as a networked device) and/or may include low-level hooks into the target UPnP apparatus 314 that allows, for example, software controlled power cycling.

In order ensure operation when the local network is unavailable, the attachment 302 may also include an alternate network interface 306 that is capable of receiving reset signals independently of such local network. The alternate interface 304 may operate over long-range wireless networks, such as Global System for Mobile communications (GSM), General Packet Radio Service (GPRS), 3^{rd} Generation (3G) Long Term Evolution (LTE), Universal Mobile Telecommunications System (UMTS), Ultra Wide Band (UWB), Wideband Code Division Multiple Access (W-CDMA), etc.

In order to communicate via cellular carrier networks, the attachment 302 may include a Subscriber Identity Module (SIM) 308 for securely storing the key used to identify a subscriber on mobile networks. The attachment 302 may also include a general or special purpose central processor 310 and memory 312 with instructions that cause the processor 310 to perform reset operations as described herein. In one example scenario, the attachment 302 can be plugged, for example, into a PC's USB port. The instructions 312 may provide IP level connectivity between the attachment 302 and the PC, and the instructions 312 may include an implementation of UPnP Remote UnPlug, RemoteUnPlug, and any other services described herein.

The hardware component 302 may provide connectivity to a home network when a primary connection through the Internet is not usable. The attachment 302 may be attached to any device in the home network, and provide for resetting not only the attached device, but other devices on the network. For example, the attachment 302 could be used to reset a remote access server (e.g., RAS 104) and/or to disable it. The attachment 302 could be programmed, either externally or by signaling to external programs, to perform a system-wide shutdown and restart in cases where unknown devices have corrupted network state.

It will be appreciated that the attachment 302 may include security provisions for preventing unauthorized access or resets of the system. For example, access to the network interface 306 may be afforded security provisions in line with the level of security used by the RAS 104. Further, the functionality of the attachment 302 may be specifically limited to sending reset signals and the like. In such a case, even if compromised, the attachment 302 may only be used to reset devices and software, and might not be used to obtain further access to the home network.

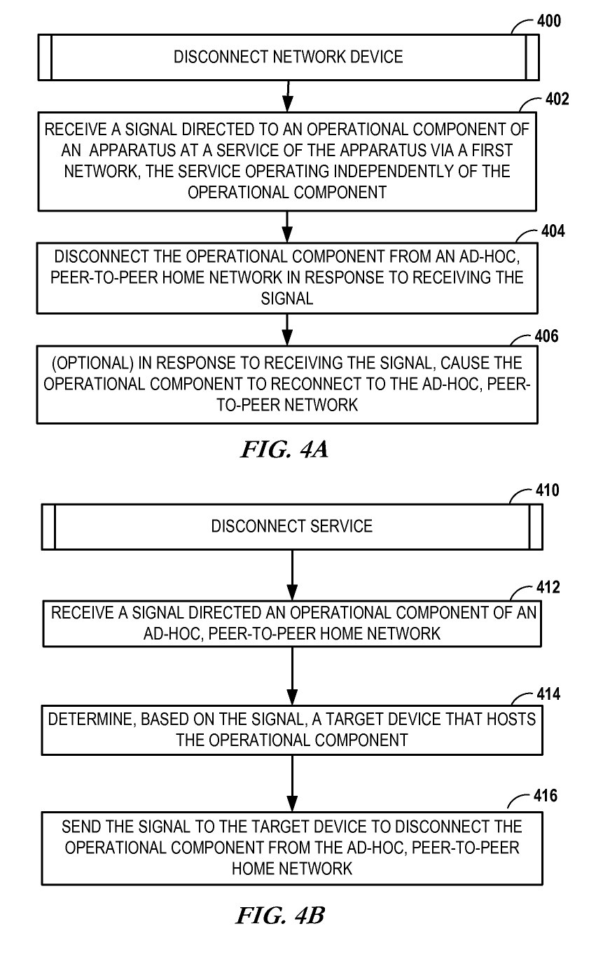

In reference now to FIG. 4A, a flowchart illustrates a procedure 400 for disconnecting a network device according to an example embodiment of the invention. A signal is received 402 at a service of an apparatus via a first network. The signal is directed to an operational component of the apparatus, and the operational component interacts via an ad-hoc, peer-to-peer home network. The service that receives 402 the signal operates independently of the operational component. The operational component is disconnected from the ad-hoc, peer-to-peer home network in response to receiving 402 the signal. Optionally, in response to receiving 402 the signal, the operational component may reconnect 406 to the ad-hoc, peer-to-peer home network.

In reference now to FIG. 4B, a flowchart illustrates a procedure 410 for a disconnect service according to example embodiments of the invention. A signal is received 412 that is directed to an operational component of an ad-hoc, peer-to-peer network. Based on the signal, a target device is determined 414 that hosts the operational component. The signal is sent 416 to the target device to disconnect the operational component from the ad-hoc, peer-to-peer home network.

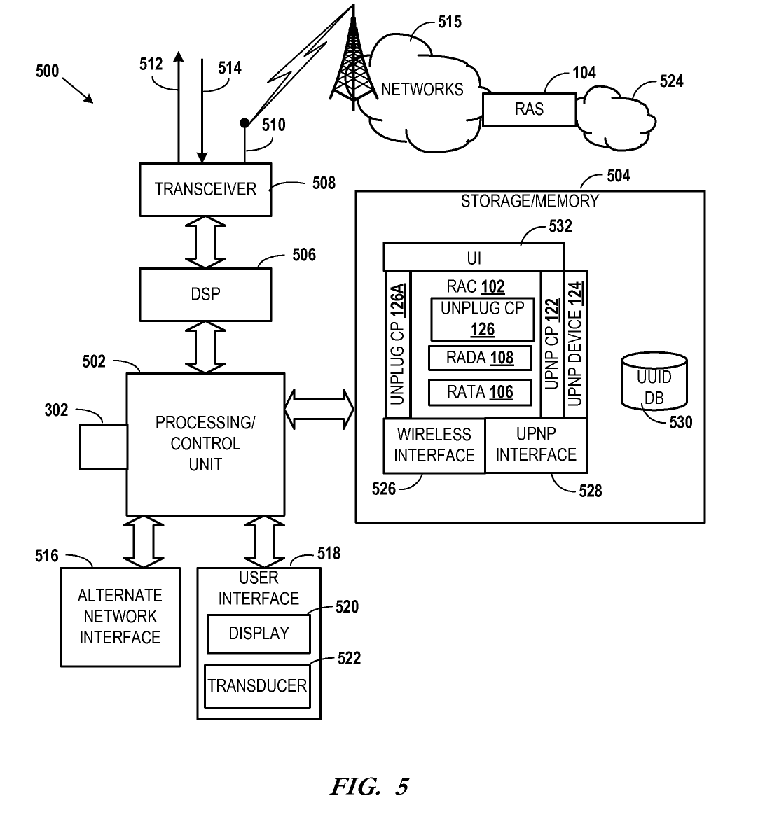

Any combination of computing hardware used to implement the functionality as described herein. In reference now to FIG. 5, an example is illustrated of a representative mobile computing device 500 capable of carrying out operations in accordance with embodiments of the invention. Those skilled in the art will appreciate that the exemplary mobile computing device 500 is merely representative of general functions that may be associated with such mobile devices, and also that landline computing systems similarly include computing circuitry to perform such operations.

The processing unit 502 controls the basic functions of the arrangement 500, and may include one or more specialized or general-purpose logic units for processing instructions. The instructions may be stored with the processing unit 502 and/or in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out mobile terminal operations in accordance with the present invention may also provided to the storage/memory 504 by computer readable medium and/or computer program products. Such software may also be transmitted to the mobile computing device 500 via data signals, such as being downloaded electronically via one or more networks, such as the Internet and intermediate wireless network(s).

The mobile computing device 500 may include hardware and software components coupled to the processing/control unit 502 for performing network data exchanges. The mobile computing device 500 may include multiple network interfaces for maintaining any combination of wired or wireless data connections. The illustrated mobile computing device 500 includes wireless data transmission circuitry for performing network data exchanges. This wireless circuitry includes a digital signal processor (DSP) 506 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 508, generally coupled to an antenna 510, transmits the outgoing radio signals 512 and receives the incoming radio signals 514 associated with the wireless device. These components may enable the arrangement 500 to join in one or more networks 515, including mobile service provider networks, local networks, and public networks such as the Internet.

The mobile computing device 500 may also include an alternate network/data interface 516 coupled to the processing/control unit 502. The alternate network/data interface 516 may include the ability to communicate via secondary data paths using any manner of data transmission medium, including wired and wireless mediums. Examples of alternate network/data interfaces 516 include USB, Bluetooth, Ethernet, 502.11 Wi-Fi, IRDA, Ultra Wide Band, WiBree, RFID, etc. These alternate interfaces 516 may also be capable of communicating via the networks 515, or via direct and/or peer-to-peer communications links.

The processor 502 is also coupled to user-interface hardware 518 associated with the mobile device 500. The user-interface 518 of the mobile device 500 may include, for example, a display 520 such as a liquid crystal display and a transducer 522. The transducer 522 may include any input device capable of receiving user inputs. The transducer 522 may also include sensing devices capable of producing media, such as any combination of text, still pictures, video, sound, etc. Other user-interface hardware/software may be included in the interface 518, such as keypads, speakers, microphones, voice commands, switches, touch pad/screen, pointing devices, trackball, joystick, vibration generators, lights, etc. These and other user-interface components are coupled to the processor 502 as is known in the art.

The program storage/memory 504 typically includes operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 504 of the mobile computing device 500 may also include software modules for performing functions according to embodiments of the present invention.

The program storage/memory 504 in this example includes various components previously described in relation to FIG. 1, including a RAC 102 that may include a RADA 108 and RATA 106 for enabling secure remote access to a home network 524 via a RAS 104. The device 500 may also host standard UPnP control point 122 and device 124 that may perform UPnP services and actions either via remote access or direct access to network 524.

The illustrated RAC 102 includes an unplug control point 126 enables remotely disconnecting and/or resetting of devices on the network 524 via the RAS 104. The memory may also include an unplug control point 126A that operates independently of any remote access functionality. The unplug control point 126A may include the capability to reset components of network 524 while directly coupled to the home network 524 and/or via public network 515.

Either unplug control point 126, 126A may be capable of resetting components of network 524 based on signals received via out-of-band mechanisms, as represented by wireless interface 526. For example, interface 526 may facilitate reset signaling via long range wireless networks using telecommunication messaging such as Simple Message Service (SMS), Multimedia Messaging Service (MMS), etc., thereby bypassing RAS 104 and/or media of network 524. The unplug control points 126, 126A may also be able to reset devices of the network 524 via a UPnP interface 528, which may include common protocol stacks shared by UPnP functional components (e.g., HTTP. SSDP, SOAP, etc.). These interfaces 526, 528 may be able to operate via primary interface 506, 508 and/or alternate network interface 516.

In one scenario, the apparatus 500 is usable to remotely access one or more devices of the home network 524 to at least send signals to cause the devices to perform any combination of disconnect, reconnect, shut down, start up, reset, etc. The signals may be targeted to one or more UUIDs, as represented by UUID database 530. This database 530 may be populated by the unplug control points 126, 126A during initial service discovery on the local network 524, and/or may be provided via a service component of the RAS 104 or some other home network server. A user interface 532 may facilitate direct user control of the signaling. Also, because the device 500 may be operable on the home network 524, it may include provisions to be reset via networks 515, 524. This may resetting of the device 500 may be performed by the unplug control points 126, 126A, and/or by attachable hardware 302 such as described in relation to FIG. 3.

The mobile computing device 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop and server computing devices similarly include a processor, memory, a user interface, and data communication circuitry. Thus, the present invention is applicable in any known computing structure where data may be communicated via a network.

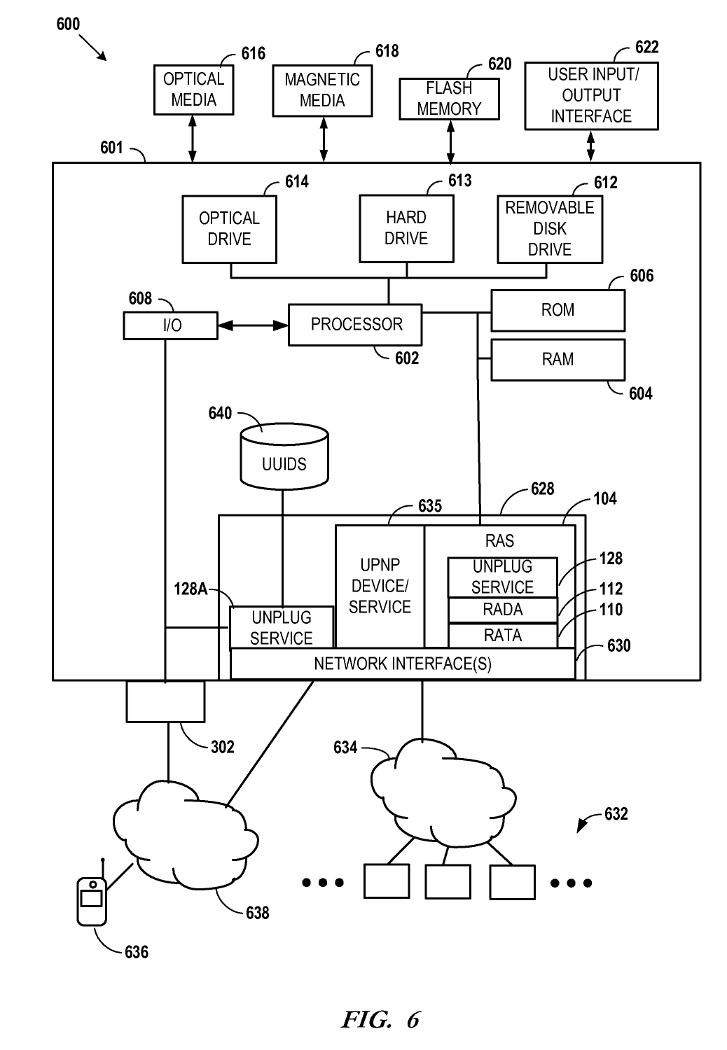

Many types of apparatuses may be able to perform roles as servers that facilitate resetting devices of a UPnP network. In reference now to FIG. 6, a block diagram provides details of a network service 600 that facilitates device and network resets according to example embodiments of the invention (e.g., analogous to various functions describe for service 122 hereinabove). The service 600 may be implemented via one or more conventional computing arrangements 601.

The computing arrangement 601 may include custom or general-purpose electronic components. The computing arrangement 601 include one or more central processors (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 may include one or more processing cores, and may include a combination of general-purpose and special-purpose processors that reside in independent functional modules (e.g., chipsets). The processor 602 carries out a variety of functions as is known in the art, as dictated by fixed logic, software instructions, and/or firmware instructions.

The computing arrangement 601 may include one or more data storage devices, including removable disk drives 612, hard drives 613, optical drives 614, and other hardware capable of reading and/or storing information. In one embodiment, software (e.g., computer program products) for carrying out the operations in accordance with the present invention may be stored and distributed on optical media 616, magnetic media 618, flash memory 620, or other form of media capable of portably storing information. These storage media may be inserted into, and read by, devices such as the optical drive 614, the removable disk drive 612, I/O ports 608 etc. The software may also be transmitted to computing arrangement 601 via data signals, such as being downloaded electronically via networks, such as the Internet. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The service 600 is configured with software programs that may be stored on any combination of memory 604 and persistent storage (e.g., hard drive 613). Such software may be contained in fixed logic or read-only memory 606, or placed in read-write memory 604 via portable computer-readable storage media and computer program products, including media such as read-only-memory magnetic disks, optical media, flash memory devices, fixed logic, read-only memory, etc. The software may also placed in memory 606 by way of data transmission links coupled to input-output busses 608. Such data transmission links may include wired/wireless network interfaces, Universal Serial Bus (USB) interfaces, etc.

The software generally includes instructions 628 that cause the processor 602 to operate with other computer hardware to provide the service functions described herein. The instructions 628 include one or more network interfaces 630 that facilitate communication with home devices 632 of a local network 634 using protocols such as UPnP. The network interface 630 may include a combination of hardware and software components, including media access circuitry, drivers, programs, and protocol modules. The network interface 630 may also include software modules for handling one or more network alternate network data transfer protocols, such as SMS, MMS, as well as protocols and media associated with voice telephony (e.g., SS-7, GSM, CDMA, etc.).

The service 600 may include remote access features described in the architecture of FIG. 1, including an RAS 104, RADA 112, RATA 110, and unplug service 128. The service 600 may also include an unplug service 128A, which here is shown operating independently of the RAS 104. The unplug services 128, 128A may be included together or separately in the service 600, and generally facilitating commanding devices 632 of the network 634 (including UPnP device/service 635 and/or processor 602 of arrangement 601) to disconnect/reset. The disconnect/reset commands may be received from a user device 636 via the local network 634 and/or another network 638. The other network 638 may include long-range wireless networks such as cellular data networks and public infrastructure networks such as the Internet.

The commands to disconnect reset devices may be received by the network interfaces 630 and/or a removable peripheral device as represented by attachment 302. Attachment 302 is described in greater detail in reference to FIG. 3, and may be capable of receiving reset signals independently of the local network 634. The attachment 302 may utilize drivers and software (e.g., unplug services 128, 128A or other system driver/service) that enable the service to unplug and reconnect devices as described elsewhere herein. The disconnect/reconnect signals may be directed to particular ones of the local devices 632, in which case the service 600 may maintain a database 640 of UUIDs to identify and signal to the target device.

For purposes of illustration, the operation of the service 600 is described in terms of functional circuit/software modules that interact to provide particular results. Those skilled in the art will appreciate that other arrangements of functional modules are possible. Further, one skilled in the art can readily implement such described functionality, either at a modular level or as a whole, using knowledge generally known in the art. The computing structure 601 is only a representative example of network infrastructure hardware that can be used to provide location-based services as described herein. Generally, the functions of the computing service 600 can be distributed over a large number of processing and network elements, and can be integrated with other services, such as Web services, gateways, mobile communications messaging, etc. For example, some aspects of the service 600 may be implemented in user devices via client-server interactions, peer-to-peer interactions, distributed computing, etc.

Any of the steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ and ‘computer’ should be understood to encompass specialized circuits such as field-programmable gate arrays, application-specific integrated circuits (ASICs), signal processing devices, computer program products, and other devices.

What is claimed is:

1. A method comprising:
receiving, at a service of an apparatus via a first network, a signal directed to an operational component of the apparatus, wherein the operational component interacts via an ad-hoc, peer-to-peer home network, and wherein the service operates independently of the operational component; and
disconnecting the operational component from the ad-hoc, peer-to-peer home network in response to receiving the signal.

2. The method of claim 1, further comprising, in response to receiving the signal, causing the operational component to reconnect to the ad-hoc, peer-to-peer network.

3. The method of claim 2, wherein disconnecting and reconnecting the operational component comprises resetting one or more network protocol stacks.

4. The method of claim 2, wherein disconnecting and reconnecting the operational component comprises resetting processing hardware of the apparatus.

5. The method of claim 1, wherein the first network comprises a cellular data network.

6. The method of claim 1, wherein the service operates on a first processor that is independent of a processor of the apparatus.

7. The method of claim 6, wherein the first processor is contained in a peripheral device that is removably coupled to the apparatus.

8. The method of claim 1, wherein the signal is received via a remote access server, and wherein the signal originates from a user device that is remotely situated from the ad-hoc, peer-to-peer network.

9. An apparatus comprising:
a network interface capable of being coupled to an ad-hoc, peer-to-peer home network, and a processor coupled to the network interface, the processor configured with instructions that cause the apparatus to,
receive, at a service of the apparatus via a first network, a signal directed to an operational component of the apparatus, wherein the operational component interacts via the ad-hoc, peer-to-peer home network, and wherein the service operates independently of the operational component; and
disconnecting the operational component from the ad-hoc, peer-to-peer home network in response to receiving the signal.

10. The apparatus of claim 9, wherein the instructions further cause the apparatus to, in response to receiving the signal, reconnect to the ad-hoc, peer-to-peer network.

11. The apparatus of claim 10, wherein disconnecting and reconnecting the operational component comprises at least one of resetting: a) one or more network protocol stacks of the apparatus; and b) processing hardware of the apparatus.

12. The apparatus of claim 9, wherein the first network comprises a cellular data network.

13. The apparatus of claim 9, wherein the service operates on a first processor that is independent of the processor of the apparatus.

14. The apparatus of claim 13, wherein the first processor is contained in a peripheral device that is removably coupled to the apparatus.

15. The apparatus of claim 9, wherein the signal is received via a remote access server, and wherein the signal originates from a user device that is remotely situated from the ad-hoc, peer-to-peer network.

16. A computer-readable storage medium encoded with instructions that, when executed by an apparatus, perform:
receiving, at a service of the apparatus via a first network, a signal directed to an operational component of the apparatus, wherein the operational component interacts via an ad-hoc, peer-to-peer home network, and wherein the service operates independently of the operational component;
disconnecting the operational component from the ad-hoc, peer-to-peer home network in response to receiving the signal.

17. The computer-readable storage medium of claim 16, wherein the instructions further cause the apparatus to, in response to receiving the signal, reconnect the operational component to the ad-hoc, peer-to-peer network.

18. The computer-readable storage medium of claim 17, wherein disconnecting and reconnecting the operational component comprises at least one of resetting: a) one or more network protocol stacks of the apparatus; and b) processing hardware of the apparatus.

19. The computer-readable storage medium of claim 16, wherein the first network comprises a cellular network.

20. The computer-readable storage medium of claim 16, wherein the service operates on a first processor that is independent of a processor of the apparatus.

21. The computer-readable storage medium of claim 16, wherein the signal is received via a remote access server, and wherein the signal originates from a user device that is remotely situated from the ad-hoc, peer-to-peer network.

22. A method comprising:
receiving a signal directed an operational component of the ad-hoc, peer-to-peer home network;
determining, based on the signal, a target device that hosts the operational component; and
sending the signal to a service of the target device to disconnect the operational component from the ad-hoc, peer-to-peer home network, wherein the service operates independently of the operational component.

23. The method of claim 22, wherein the signal is received at a remote access interface that facilitates accessing the ad-hoc, peer-to-peer home network via an external network.

24. The method of claim 22, wherein the signal is received via a cellular data network.

25. The method of claim 22, wherein sending the signal to the service of the target device further causes the operational component to reconnect to the ad-hoc, peer-to-peer network after disconnecting.

26. An apparatus comprising:
a network interface capable of being coupled to an ad-hoc, peer-to-peer home network, and a processor coupled to the network interface, the processor configured with instructions that cause the apparatus to,
receive a signal directed an operational component of the ad-hoc, peer-to-peer home network;
determine, based on the signal, a target device that hosts the operational component; and
send the signal to a service of the target device to disconnect the operational component from the ad-hoc, peer-to-peer home network, wherein the service operates independently of the operational component.

27. The apparatus of claim 26, further comprising a remote access interface that facilitates accessing the ad-hoc, peer-to-peer home network via an external network, and wherein the signal is received at the remote access interface.

28. The apparatus of claim 26, further comprising a cellular data interface that is capable of being coupled to a cellular data network, and wherein the signal is received via the cellular data network.

29. The apparatus of claim 26, wherein sending the signal to the service of the target device further causes the operational component to reconnect to the ad-hoc, peer-to-peer network after disconnecting.

30. A computer-readable storage medium encoded with instructions that, when executed by an apparatus, perform:
receiving a signal directed an operational component of the ad-hoc, peer-to-peer home network;
determining, based on the signal, a target device that hosts the operational component; and
sending the signal to a service of the target device to disconnect the operational component from the ad-hoc, peer-to-peer home network, wherein the service operates independently of the operational componen.

31. The computer-readable storage medium of claim 30, wherein the signal is received at a remote access interface of the apparatus that facilitates accessing the ad-hoc, peer-to-peer home network via an external network.

32. The computer-readable storage medium of claim 30, wherein the signal is received via a cellular data network.

33. The computer-readable storage medium of claim 30, wherein sending the signal to the service of the target device further causes the operational component to reconnect to the ad-hoc, peer-to-peer network after disconnecting.
